(19) United States
(12) Patent Application Publication
(10) Pub. No.: US 2018/0189795 A1
(43) Pub. Date: Jul. 5, 2018

(54) SYSTEM AND METHOD FOR PROVIDING ENHANCED INTERACTIVE SESSIONS VIA DIGITAL CHANNELS

(71) Applicant: CallVU Ltd., TEL AVIV (IL)

(72) Inventors: Assaf FRENKEL, Ramat HaSharon (IL); Ori FARAN, Modiin (IL)

(73) Assignee: CallVU Ltd., TEL AVIV (IL)

(21) Appl. No.: 15/855,539

(22) Filed: Dec. 27, 2017

Related U.S. Application Data
(60) Provisional application No. 62/440,193, filed on Dec. 29, 2016.

(51) Int. Cl. G06Q 30/00; H04L 12/58; H04M 3/51

(52) U.S. Cl. CPC G06Q 30/016; H04L 51/02; H04L 67/10; H04M 3/5166; H04M 3/5191

(57) ABSTRACT

A system and method for providing enhanced interactive sessions via digital channels. The method includes establishing, by a bot integration system, a first channel with a bot; establishing, by the bot integration system, a second channel with at least one service system; and initiating, by the bot integration system, an enhanced interactive session via the second channel, wherein conducting the enhanced interactive session includes communicating transaction data between the bot integration system and the at least one service system based on communications sent via the first channel.

### CROSS-REFERENCE TO RELATED APPLICATIONS

This application claims the benefit of U.S. Provisional Application No. 62/440,193 filed on Dec. 29, 2016, the contents of which are hereby incorporated by reference.

### TECHNICAL FIELD

The present disclosure generally relates to customer interactions, and more particularly to enabling self-service and assisted service in digital channels.

### BACKGROUND

One challenge facing companies, organizations, and enterprises today is communicating with their customers, both in person and remotely. Many such entities utilize call centers to provide such communications. A call center is a unit within an entity that is used for receiving and handling requests for services, information, and/or purchases.

Customer service representatives (CSRs) mainly communicate with customers via telephone calls and/or text communications. However, the human channel normally offers a very lean scope of communication and lacks both the visual richness and the tools available on digital channels such as web and mobile applications. Historically, customers seeking services, information, or purchases would contact a CSR via, for example, telephone through a call center.

As an alternative to traditional telephonic communications, many call centers now use electronic self-service channels such as interactive voice response (IVR) systems that provide information and/or call routing by leading a user through a series of menu-driven voice prompts. IVR systems are commonly used for automating customer service call routing and automated account information (e.g., bank account information).

Users of such systems can experience problems navigating through the menu. Thus, frustrated users often abandon their quest for information and terminate the telephone call prior to reaching the sought information. When users abandon the automated information delivery system, they typically seek a human attendant to connect with to obtain the information originally sought. This increases the demand for human agents in call centers, thereby increasing the cost of operating an automated information delivery system.

In addition, users that are required to traverse a voice-read menu tree commonly become frustrated with menu-driven information delivery systems and resort to contacting a human operator. Typically, menu-driven information delivery systems do not enable the user to navigate directly to the desired information and/or service, but rather require the user to traverse a predefined path through the menu tree to the user's objective.

Further, companies often seek to attract customers to digital channels instead of or in addition to the human channel. Utilizing a mix of human and digital channels often creates difficulties. There is usually no continuity between the digital channels and the human channels and, thus, a desired continuous interaction of a customer is actually broken into a number of separate interactions (e.g., web self-service to call an IVR to talk with an agent to fax a form to call to check if fax received). Furthermore, human channels are typically limited in that they do not offer visuals and other tools that may be available via digital communications.

In recent years, new communication channels have quickly been emerging and have been adopted rapidly by consumers for social communication. Texting and messaging applications are more widely used than phone calls. Messaging is also prevalent in social networks like Facebook®, and messaging applications have even become social networks themselves (e.g., Whatsapp®).

Another relatively new technology for communication is known as an internet bot (or simply bot). A bot is a software application that executes automated tasks (scripts) over the Internet. Typically, bots perform tasks that are both simple and structurally repetitive, at a much higher rate than would be possible for a human alone. Given the exceptional speed with which bots can perform their relatively simple routines, bots may also be implemented where a response speed faster than that of humans is required. For example, a chat bot emulating human activity may be utilized to more efficiently respond to high numbers of calls than human operators. However, bots face many of the challenges noted above, particularly with respect to lack of continuity with other channels.

Currently, when organizations try to follow customers to these new channels, they usually start with manual or agent driven responses, and hesitate to design and implement new processes and self-service options to these channels. Additionally, as more services become cloud-based, it is desirable for IVR and other customer service operations to be adapted to cloud environments.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for providing enhanced interactive sessions via digital channels. The method comprises: establishing, by a bot integration system, a first channel with a bot; establishing, by the bot integration system, a second channel with at least one service system; and initiating, by the bot integration system, an enhanced interactive session via the second channel, wherein conducting the enhanced interactive session includes communicating transaction data between the bot integration system and the at least one service system based on communications sent via the first channel.

Certain embodiments disclosed herein also include a non-transitory computer readable medium having stored thereon causing a processing circuitry to execute a process, the process comprising: establishing, by a bot integration system, a first channel with a bot; establishing, by the bot integration system, a second channel with at least one service system; and initiating, by the bot integration system, an enhanced interactive session via the second channel, wherein conducting the enhanced interactive session includes communicating transaction data between the bot integration system and the at least one service system based on communications sent via the first channel.

Certain embodiments disclosed herein also include a system for providing enhanced interactive sessions via digital channels. The system comprises: a processing circuitry; and a memory, the memory containing instructions that, when executed by the processing circuitry, configure the system to: establish a first channel with a bot; establish a second channel with at least one service system; and initiate an enhanced interactive session via the second channel, wherein conducting the enhanced interactive session includes communicating transaction data between the bot integration system and the at least one service system based on communications sent via the first channel.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a screenshot demonstrating the integration of a bot in a social media network.

FIG. 2 is a screenshot demonstrating the integration of a bot in an enterprise website.

FIG. 3 is a network diagram utilized to describe the various disclosed embodiments.

FIG. 4 is a flow diagram illustrating the operation of the system according to an embodiment.

FIG. 5 is a network diagram utilized to describe cloud-based bot integration according to an embodiment.

FIG. 6 is a schematic diagram illustrating a bot integration system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Various disclosed embodiments include techniques for integrating existing contact center channels with bot channels. The existing channels may include voice channels, data channels, and the like. In an example implementation, the existing channels are utilized to provide interactive voice response (IVR) services, other self-assistance services (“self-services”), both, and the like. The disclosed embodiments make it possible to augment self-service options from the existing channels to new bot channels.

The disclosed embodiments include techniques for transforming existing self-service operations (e.g., operations in IVRs, web sites, mobile applications, combinations thereof, etc.) into a service bot, and augmenting such capabilities with additional processes and with the adaption needed for a new channel. To this end, the disclosed embodiments provide a new service as an intermediate layer via a bot integration system. This intermediate layer enables fast time to market for a bot.

In an embodiment, a self-service channel is integrated with a data channel to form a combined service. A bot is configured to access the combined service and to execute automated tasks based on data, functionality, or both, provided by the combined service. The bot can be integrated on-premises of an enterprise or in a cloud environment. The disclosed embodiments may further be adapted to cloud environments, where the bot is integrated within a cloud-based contact center system.

In an embodiment, the bot is configured to mimic an interaction with a live representative at a call center. To this end, the disclosed embodiments include converting a self-service session into a collaboration session with a bot. This collaboration session can be initiated on a different channel. In some implementations, the collaboration session may be initiated in parallel with a voice call or self-service session. As a non-limiting example, a bot running on the Facebook® website accessed from a browser of a user's desktop can be converted into a voice call with an agent, and a bot-based collaboration session may be opened on the user's mobile phone during the call.

The disclosed embodiments allow for enhancing exiting self-service channels with bot functionality. In particular, existing self-service channels may be merged with bot channels to enable switching from the self-service channels to the bot channels, thereby allowing for repurposing of self-service sessions into assisted sessions. Additionally, self-service sessions may be converted into assisted sessions instead of or in parallel with a voice call.

The cloud-based embodiments allow for integration of bots with cloud services rather than with individual enterprise services, thereby allowing for improved flexibility with respect to addition or removal of enterprises. Specifically, when multiple entities utilize contact center services hosted in the same cloud environment, the bot may be deployed in the cloud environment and integrated with each entity indirectly. This allows for increased efficiency and reduced complexity of providing contact center services.

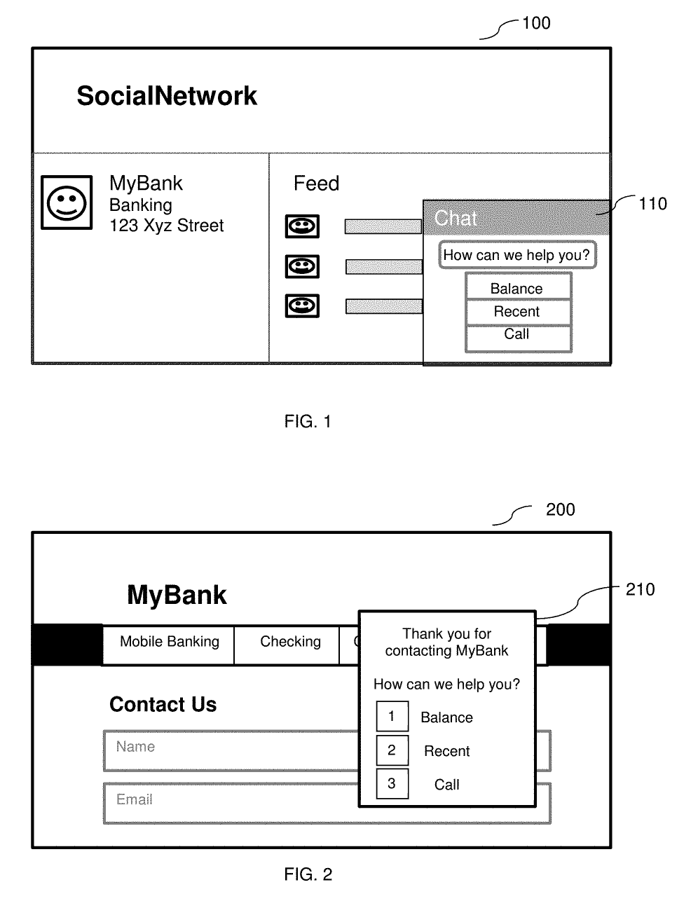

FIGS. 1 and 2 are example screenshots illustrating integration of bot channels with existing self-service channels from an end user's perspective according to some disclosed embodiments. FIG. 1 shows a bot assistance chat box 110 overlaid on a view of a social networking website. The chat box 110 may be opened when the user interacts with a service request portion (not shown) of the social networking website. FIG. 2 shows a bot assistance chat box 210 overlaid on a view of a website of “MyBank.” The chat box 210 may be opened when the user interacts with a service request portion (not shown) of the MyBank website.

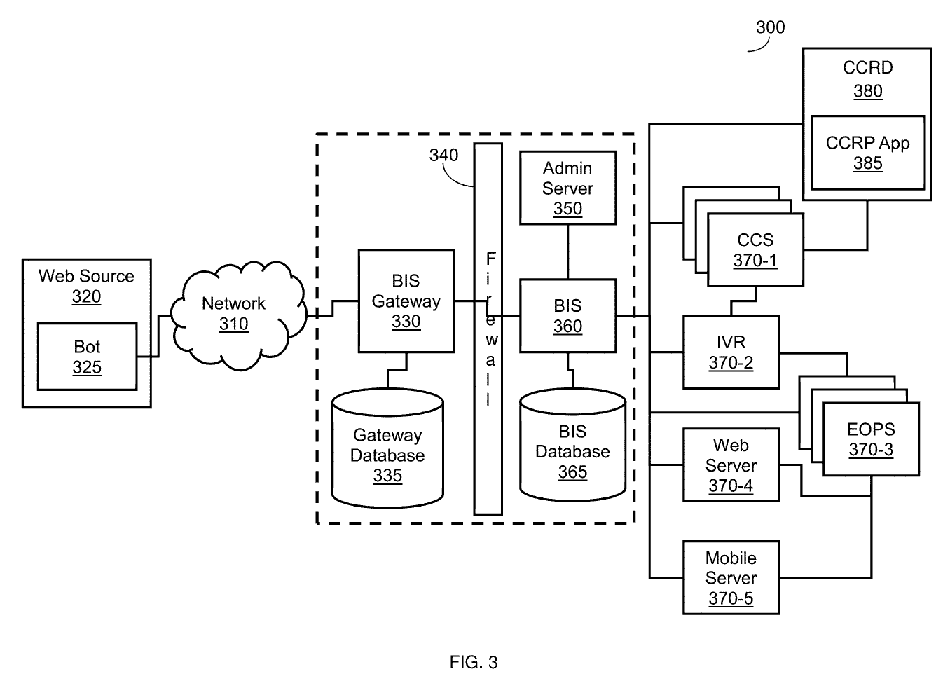

FIG. 3 is an example network diagram 300 utilized to describe various disclosed embodiments. The network diagram 300 includes a network 310, a web page 320 including a bot 325, a BIS gateway 330, a gateway database 335, a firewall 340, an admin server 350, a bot integration system 360, a BIS database 365, and a contact center representative device (CCRD) 380 including a contact center representative portal application (CCRP App) 385. The network diagram 300 also includes one or more service systems 370 (hereinafter referred to collectively as service systems 370 or individually as a service system 370, merely for simplicity purposes) such as, but not limited to, a contact center system (CCS) 370-1, an IVR 370-2, an enterprise operational system (EOPS) 370-3, a web server 370-4, a mobile server 370-5, a combination thereof, and the like. Each component of the network diagram 300 may access different APIs based on an access level of the component.

The network 310 may be, but is not limited to, a wireless, cellular or wired network, a local area network (LAN), a wide area network (WAN), a metro area network (MAN), the Internet, the worldwide web (WWW), similar networks, and any combination thereof. The components of the network diagram 300 may be communicatively connected via the network 310.

The web source 320 may host a website or other service through which users may communicate via user devices (not shown). The web source 320 may be, but is not limited to, a server of an enterprise, of a social media platform, and the like. The web source 320 is configured to initiate a bot 325 in response to user interaction with the service. As a non-limiting example, the bot 325 may be initiated in response to a user clicking on a button appearing on a web page.

The bot 325 is a software application installed on the web source 320 and configured to perform one or more automated scripts. In an example implementation, the automated tasks may include mimicking human behavior and assisting users with questions or requests for services over the Internet.

The bot integration system (BIS) gateway 330 is communicatively connected to the bot 325 via the network 310. The BIS gateway 330 is configured to manage communications between the bot 325 and the bot integration system 360, and to receive initiation messages from the bot 325. The gateway database 335 stores data utilized to support the operation of the BIS gateway 330. In some implementations, the BIS gateway 330 and the gateway database 335 may be integrated in the same device.

The BIS gateway 330 is also communicatively connected to the bot integration system 360. A firewall 340 may be deployed in line between the BIS gateway 330 and the bot integration system, and is configured to control traffic between the BIS gateway 330 and the bot integration system 360.

In an embodiment, the bot integration system 360 is communicatively connected to an admin server 350, a BIS database 365, the one or more service systems 370, and the contact center representative device 380. The bot integration system 360 is configured to integrate self-service channels utilized for communications via the service systems 370 with a bot channel utilized by the bot 325.

The admin server 350 is configured to control the processes executed by the bot integration system 360. The admin server 350 may be configured to receive instructions from a user (e.g., from a system administrator via a user interface, not shown). In an example implementation, the BIS gateway 330 can initiate a session to the bot integration system 360, which is separated by the firewall 340.

The bot integration system 360 may be communicatively connected to one or more of the service systems 370, the contact center representative device 380, or both. The service systems 370 are configured to provide services to users such as, but not limited to, contact center services, self-assisted service (e.g., IVR), both, and the like. The following is a discussion of some example service systems 370 that are shown in FIG. 3.

The CCS 370-1 is configured to enable telephonic communications with users during a live session with a contact center representative (CCR, e.g., a customer service representative). The CCS 370-1 is configured to allow the CCR (e.g., a CCR using the CCRD 380) to utilize the capabilities of the digital tools to better serve the customer during a live interaction to improve customer experience and contact center performance. It should be appreciated that the CCS 370-1 can turn mobile applications and web sites into hybrid self-assistance tools. To this end, the CCS 370-1 may be configured to provide contact center data, bot data, or both, to the CCRD 380, thereby allowing for the contact center representative using the CCRD 380 to access contact center data during a live telephonic session with a user.

The CCRD 380 may be configured with browsing, viewing, and other capabilities utilized by a contact center representative. The CCRD 380 may further be configured for telephonic communications. To this end, the CCRD 380 may be, but is not limited to, a smart phone, a tablet computer, a laptop computer, a desktop computer, and the like. In an embodiment, the CCRD 380 has installed thereon a contact center representative portal application (CCRP App) 385. The CCRP app 385 may be configured to provide session context and manage the collaboration process between the bot 325 and the user of the CCRD 380. The CCRP app 385 may be, but is not limited to, a native application, a mobile application, a cloud application, and the like.

The CCS 370-1 may also be configured to establish and facilitate communications with various systems typically deployed in the contact center. Such systems may include, but are not limited to, a computer telephony integration (CTI) system, a CRM system, and the like.

According to various disclosed embodiments, during a live session between a CSR and a user (e.g., during a call between a CSR using the CCRD 380 and a user browsing a website hosted by the web source 320), the bot 325 is configured to initiate communications through the BIS gateway 330 and the bot integration system 360 to initiate a bot assistance session via the CCS 370-1. The bot integration system 360 is configured to merge a data channel utilized by the CCS 370-1 with the channel utilized by the bot 325. The bot integration system 360 may be further configured to initiate a call or callback with a session ID based on a phone number provided by the user in parallel with the merged channel.

The IVR system 370-2 provides information, call routing, or both, by leading a user through a series of menu-driven prompts. The IVR system 370-2 may be configured to execute a set of commands which encapsulate the display requests. Such commands may be programmed or designed based on data retrieved from customer relation management (CRM) servers, Enterprise Resource Planning (ERP) servers, and the like.

The EOPS 370-3 include any systems that may perform billing, contact auditing, and the like, for an organization. The EOPS 370-3 may retrieve information from the IVR 370-2, from the bot integration system 360, or both.

In an embodiment, any of the interactions between the bot integration system 360 and the service systems 370, the CCRD 380, or both may be based on unique tokens. Each unique token may be generated, e.g., per session. Each interaction may further be registered and stored in the BIS database 365 along with its respective unique session token. Additional parameters may also be stored in the BIS database 365 respective of the interaction. Such parameters may include, but are not limited to, a phone number of a client device, a registration code, and so on.

In an embodiment, the bot integration system 360 may be configured to provide a health-check Application Programming Interface (API). The health-check API may be utilized for, e.g., controlling availability of the resources accessible to the bot integration system 360.

The bot integration system 360, BIS gateway 330, admin server 350 and databases 335 and 365 collectively operate to provide combined channels that merge bot channels with self-service, voice, or other channels. To this end, it is noted that these components are shown in FIG. 3 as distinct merely for example purposes, and that any of these components may be implemented as a single system without departing from the scope of the disclosure.

It should be noted that the network diagram 300 may include additional databases (not shown) without departing from the scope of the disclosure. The additional databases may be communicatively connected to, for example, the bot integration system 360, the BIS database 365, or both. Such databases may include, but are not limited to, a CRM database, an interactive voice response database, and so on. Data collected during pre-call sessions may be stored in such additional databases and subsequently accessed via, e.g., database APIs respective of the additional databases.

It should also be noted that the web source 320, the service systems 370, and the contact center representative device 380 shown in FIG. 3 are merely utilized to demonstrate various examples, and that additional, fewer, or different web sources, service systems, and contact center representative devices may be equally utilized without departing from the scope of the disclosure. Further, multiple bots may be utilized, with different bots allowing for different bot channels. It should further be noted that any of the components of the network diagram 300 may be geographically distributed without departing from the scope of the disclosure.

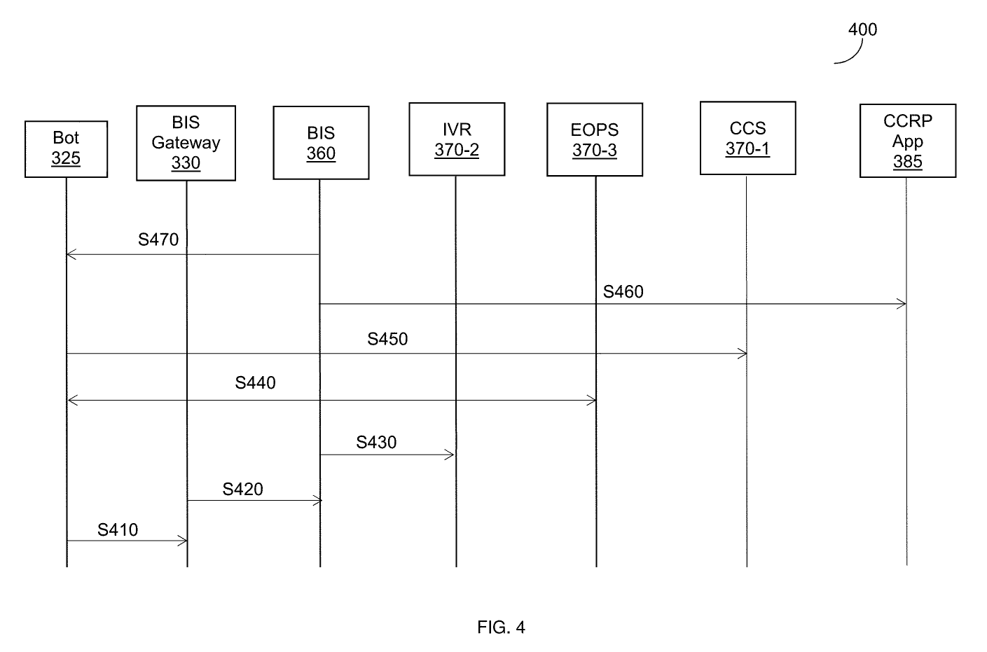

FIG. 4 shows an example flow diagram illustrating operations among the network diagram 300 according to an embodiment.

At S410, upon detection of a service request initiated by a user, the bot 325 is instantiated and communications are established with the BIS gateway 330.

At S420, the BIS gateway 330 initiates a data session with the bot integration system 360.

At S430, a data session is initiated between the bot integration system 360 and the IVR 370-2. In an alternative embodiment, the process of implementing certain functions of the IVR 370-2 is initiated in the bot integration system 360.

At S440, the session's transactional data is requested and sent to the bot 325 from the EOPS 370-3 through the IVR 370-2. The transactional information is retrieved from the EOPS 370-3 through the connections established with the IVR 370-2, and sent to the bot 325 via the BIS gateway 330 and the bot integration system 360. In an embodiment, S440 includes iterative sending of data back and forth between the bot 325 and the EOPS 370-3.

At optional S450 through S470, when a live communication with a contact center representative is needed, a live session is established in parallel with the bot session. Specifically, at S450, the bot 325 initiates a connection to the CCS 370-1 through the BIS gateway 330 and the bot integration system 360 to initiate a telephonic session with a session ID based on a phone number provided by the user. The telephonic session includes an ongoing call or a callback, and is in parallel to the session established with the bot.

At S460, a combined session is initiated by the bot integration system 360 between the CCRP app 385 and the bot 325. Alternatively, the session is initiated separately to a user device (not shown). At optional S470, data received from the CCRP app 385 may be sent to the bot 325. The data received from the CCRP app 385 may be based on, for example, inputs provided by a user of the CCRD 380.

It should be noted that anytime during an active session, an attendant can communicate with the user device over the data session with messages in formats including, but not limited to, short message service (SMS) messages, email messages, multimedia messaging service (MMS) messages, images, video clips, audio clips, any combination thereof, and the like. It should be further noted, that as the user and the attendant can exchange messages, a chat session can be established between the two parties. An attendant can participate in chat session with multiple users.

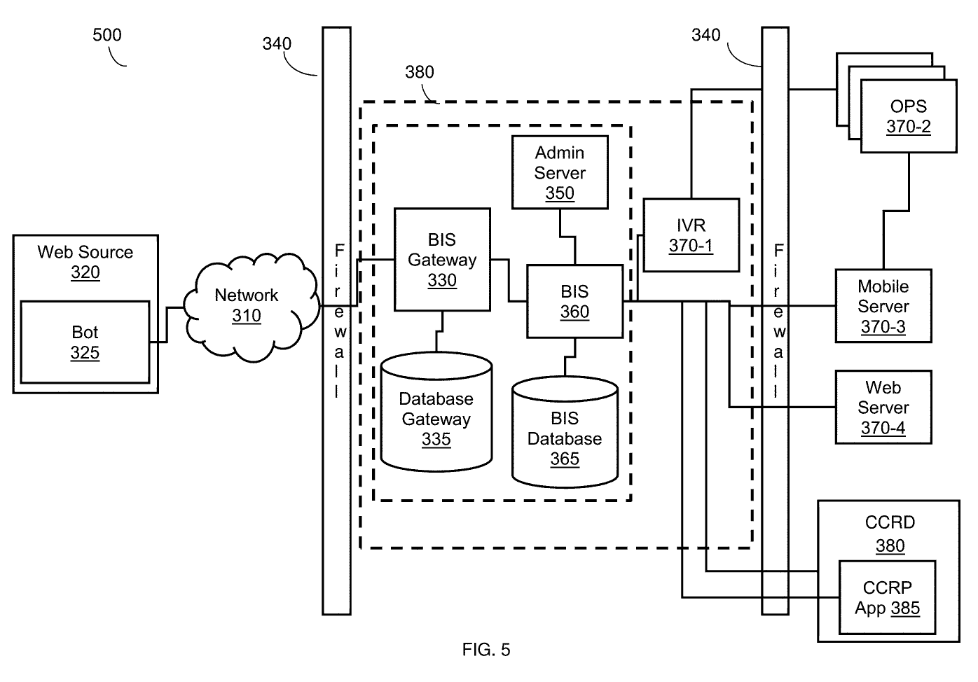

FIG. 5 is an example network diagram 500 illustrating a cloud-based deployment of the bot integration system 360 according to an example implementation. In the example network diagram 500, the BIS gateway 330, the admin server 350, the bot integration system 360, the gateways 335 and 365, and the IVR system 370-1 are deployed in a cloud computing environment 380. The cloud computing environment 380 may be, for example but not limited to, a cloud computing environment of a cloud service provider (e.g., Amazon®). In some implementations, the cloud service provider may provide services via the cloud computing environment such as, for example, IVR services via the IVR system 370-1. Firewalls 340 may be deployed in line between the web source 320 and the BIS gateway 330 as well as between the cloud environment 380 and the service systems 370 and contact center representative device 380.

Deploying the bot integration system 360 in the cloud computing environment 380 allows for near seamless integration of new service systems 370 as compared to deploying the bot integration system 360 on-premises of an enterprise network (using, for example the configuration shown in FIG. 3). Specifically, combined channels may be provided without integrating the bot integration system 360 directly into an enterprise's systems. Thus, when multiple entities utilize the same cloud service provider and, consequently, the same cloud computing environment 380, combined channels may be provided more efficiently than when the bot integration system 360 is deployed locally for each entity.

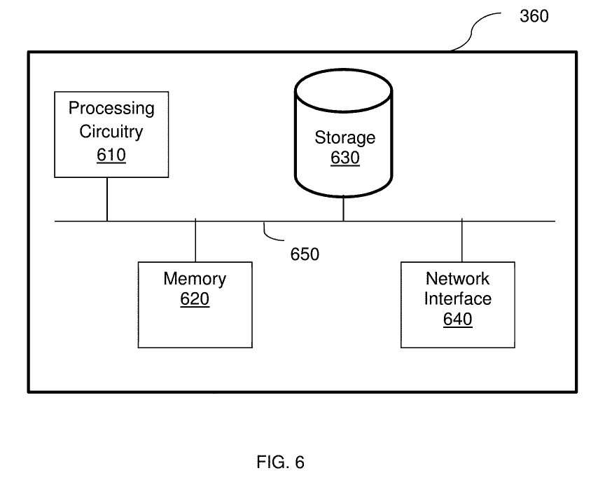

FIG. 6 is an example schematic diagram of the bot integration system 360 according to an embodiment. The bot integration system 360 includes a processing circuitry 610 coupled to a memory 620, a storage 630, and a network interface 640. The components of the bot integration system 360 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 620 may be volatile (e.g., RAM, etc.), non-volatile (e.g., ROM, flash memory, etc.), or a combination thereof. In one configuration, computer readable instructions to implement one or more embodiments disclosed herein may be stored in the storage 630.

In another embodiment, the memory 620 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 610 to perform the various processes described herein. Specifically, the instructions, when executed, cause the processing circuitry 210 to perform the embodiments described herein.

The storage 630 may be magnetic storage, optical storage, and the like, and may be realized, for example, as flash memory or other memory technology, CD-ROM, Digital Versatile Disks (DVDs), or any other medium which can be used to store the desired information.

The network interface 640 allows the bot integration system 360 to communicate with, for example, the BIS gateway 330, the admin application 350, the BIS database 365, the service systems 370, the contact center representative device 380, or a combination of, for the purpose of, for example, retrieving data, storing data, combining communications channels, and the like.

It should be understood that the embodiments described herein are not limited to the specific architecture illustrated in FIG. 6, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for providing enhanced interactive sessions via digital channels, comprising:
establishing, by a bot integration system, a first channel with a bot;
establishing, by the bot integration system, a second channel with at least one service system; and
initiating, by the bot integration system, an enhanced interactive session via the second channel, wherein conducting the enhanced interactive session includes communicating transaction data between the bot integration system and the at least one service system based on communications sent via the first channel.

2. The method of claim 1, wherein the bot integration system is deployed on premises with the at least one service system.

3. The method of claim 1, wherein the bot integration system is deployed in a cloud environment.

4. The method of claim 3, wherein the at least one service system includes an interactive voice response (IVR) system, wherein the IVR system is deployed in the cloud environment.

5. The method of claim 1, further comprising:
initiating a live session with a contact center representative device in parallel with the session initiated via the second channel.

6. The method of claim 5, wherein the live session includes telephonic communications.

7. The method of claim 1, wherein the at least one service system includes at least one of: an interactive voice response (IVR) system, a web source hosting a web page, and mobile application.

8. The method of claim 1, wherein the enhanced interactive session includes an interface for communicating with the bot.

9. A non-transitory computer readable medium having stored thereon instructions for causing a processing circuitry to execute a process, the process comprising:
establishing, by a bot integration system, a first channel with a bot;
establishing, by the bot integration system, a second channel with at least one service system; and
initiating, by the bot integration system, an enhanced interactive session via the second channel, wherein conducting the enhanced interactive session includes communicating transaction data between the bot integration system and the at least one service system based on communications sent via the first channel.

10. A system for providing enhanced interactive sessions via digital channels, comprising:
a processing circuitry; and
a memory, the memory containing instructions that, when executed by the processing circuitry, configure the system to:
establish a first channel with a bot;
establish a second channel with at least one service system; and
initiate an enhanced interactive session via the second channel, wherein conducting the enhanced interactive session includes communicating transaction data between the bot integration system and the at least one service system based on communications sent via the first channel.

11. The system of claim 10, wherein the system is deployed on premises with the at least one service system.

12. The system of claim 10, wherein the system is deployed in a cloud environment.

13. The system of claim 12, wherein the at least one service system includes an interactive voice response (IVR) system, wherein the IVR system is deployed in the cloud environment.

14. The system of claim 10, wherein the system is further configured to:
initiate a live session with a contact center representative device in parallel with the session initiated via the second channel.

15. The system of claim 14, wherein the live session includes telephonic communications.

16. The system of claim 10, wherein the at least one service system includes at least one of: an interactive voice response (IVR) system, a web source hosting a web page, and mobile application.

17. The system of claim 10, wherein the enhanced interactive session includes an interface for communicating with the bot.
